(19) United States
(12) Patent Application Publication
(10) Pub. No.: US 2025/0369882 A1
(43) Pub. Date: Dec. 4, 2025

(54) AUTOMATIC TEST VERIFICATION IN A TEST SYSTEM AND A TEST DEVICE FOR DETECTING A TARGET ANALYTE

(71) Applicant: MIDGE MEDICAL GMBH, Berlin (DE)

(72) Inventors: Elena GRAF, Berlin (DE); Jesus BUENO, Berlin (DE); Aiko WEBER, Berlin (DE); Christian WAHNES, Berlin (DE)

(21) Appl. No.: 18/707,016

(22) PCT Filed: Nov. 4, 2022
(86) PCT No.: PCT/EP2022/080888

§ 371 Date: May 2, 2024

(30) Foreign Application Priority Data
Nov. 4, 2021 (EP) 21206540.3

(51) Int. Cl. G01N 21/64

(52) U.S. Cl. CPC G01N 21/6408; G01N 2021/6421

(57) ABSTRACT

The invention relates to a testing system, a detection device for the testing system and a method of operating the testing system. The testing system is for test a sample that may comprise an analyte. The testing system comprises comprising a detection device (10) and an analyte detection subsystem (110) and a test verification subsystem (120). The detection device (10) comprises a detection chamber (12) and at least one light sensor (16) for recording and/or sampling of light intensities of light in different frequency ranges over time. The analyte detection subsystem (110) is configured to detect the presence of an analyte in a sample that is arranged in the detection chamber (12), and the test verification sub-system (120) is configured to process the time courses of light intensities for detecting whether the test performed with the detection device (10) is valid or invalid.

The invention relates to a test system and a test device for detecting a target analyte, in particular a target nucleic acid, for instance DNA or RNA, by way of isothermal nucleic acid amplification and fluorescence.

Nucleic acid amplification technologies are used to amplify the amount of a target nucleic acid in a sample in order to detect such target nucleic acid in the sample. A known nucleic acid amplification technology is Polymerase Chain Reaction (PCR). Isothermal nucleic acid amplification technologies offer advantages over polymerase chain reaction (PCR) in that they do not require thermal cycling or sophisticated laboratory equipment.

Known isothermal nucleic acid amplification technologies are inter alia Recombinase Polymerase Amplification (RPA) and Strand Invasion Based Amplification (SIBA) and other methods known to persons skilled in the art.

Recombinase polymerase amplification (RPA), is a method to amplify the amount of a target analyte, in particular a nucleic acid such as DNA or RNA in a sample. For Recombinase Polymerase Amplification three core enzymes are used: a recombinase, a single-stranded DNA-binding protein (SSB) and a strand-displacing polymerase. Recombinases can pair oligonucleotide primers with homologous sequences in duplex DNA. SSB binds to displaced strands of DNA and prevents the primers from being displaced. The strand-displacing polymerase begins DNA synthesis at sites where the primer has bound to the target DNA. Thus, if a target gene sequence is indeed present in the tested sample, an exponential DNA amplification reaction can be achieved to amplify a small amount of a target nucleic acid to detectable levels within minutes at temperatures between 37° C. and 42° C.

The three core RPA enzymes can be supplemented by further enzymes to provide extra functionality. Addition of exonuclease III allows the use of an exo probe for real-time, fluorescence detection. If a reverse transcriptase that works at 37 to 42° C. is added then RNA can be reverse transcribed and the cDNA produced amplified all in one step.

By adding a reverse transcriptase enzyme to an RPA reaction, it can detect RNA as well as DNA, without the need for a separate step to produce cDNA. It is an advantage of RPA that it is isothermal and thus only requires simple equipment. While RPA operates best at temperatures between 37° C. and 42° C. it still works at room temperature.

For detecting the presence of a targeted nucleic acid in a sample, fluorescence detection technique can be used. After the light source at specific wavelength illuminates on the targeted nucleic acids, the DNA-binding dyes or fluorescein-binding probes of the nucleic acids will react and enable fluorescent signals to be emitted. The fluorescent signal is an indication of the existence of the targeted nucleic acids.

Diagnostic test systems typically require quality assurance during use, to ensure that inappropriate handling by the user or unsuccessful biochemical reaction, e.g. caused by impaired reagents, is not mistaken as negative result. The requirement for quality assurance during use applies for isothermal amplification reactions used to detect specific nucleic acid sequences, e.g. RPA reaction of virus RNA (after conversion to respective DNA via reverse transcription (RT)). Here, the use of so called “Duplex” assays is the gold standard—a second piece of RNA/DNA is amplified in parallel to verify that the reaction as such was running idle. Nevertheless, this approach has some drawbacks, especially at low concentration of the analyte: sensitivity can be reduced because amplification reagents are needed for the second reaction. Further, development and validation of such systems manifolds the complexity, thus leading to higher effort, and loss in robustness.

It is an object of the invention to reduce the effort needed for quality assurance without compromising the reliability of the quality assurances.

Therefore it is suggested to use a simplex system (i.e. amplifying only analytical target RNA/DNA), that grants higher robustness and sensitivity compared to the duplex system and to perform a reliable integrated quality assessment of the test by non-chemical means, for instance by evaluating signals recorded and/or sampled by a detection device during a diagnostic test. As a further advantage of such highly effective end-user enabled diagnostic test typical user errors during preparation and initiation of the reaction can be detected.

As recombinase polymerase amplification (RPA) (and its combination with prior reverse transcription (RT)) is a reaction leading to an exponential amplification, it is running too less controlled to be tamed and evaluated simply by exact control of environmental conditions, like e.g. polymerase chain reaction (PCR) with its cycles and respective analytical quantification of its cycles.

Therefore, there is a need to control the integrity of the testing process in order to avoid false positive and/or false negative test results caused by a compromised test procedure.

To meet this need, a test system and a detection device is provided that comprises a detection chamber, at least one light source, at least one light sensor and a control/evaluation unit.

The light source is configured and arranged to illuminate the detection chamber at least in part.

The light sensor is arranged to detect and record light in the detection chamber. The light source, the light sensor and the detection chamber are configured and arranged so as to prevent light emitted from the light source from directly impinging the light sensor. The light sensor is further configured to record light in at least two different ranges of wavelengths and to provide at least two output signals, each time series of output signal representing the temporal development of an intensity of light in a respective range of wavelengths (channel). Accordingly, the light sensor has at least two channels. One channel is defined by a range of wavelengths (i.e. a light band) the sensor can sense and an output signal representing the sensed light intensity in that range of wavelengths. The channels, i.e. the ranges of wavelengths, may overlap but are sufficiently distinct so the sensor can discriminate light intensities in different channels.

The control/evaluation unit is adapted to evaluate the at least two output signals of the light sensor.

Preferably, the at least two channels include a luminescence channel for capturing light in a luminescence frequency range in which luminescence occurs in case an analyte to be detected is present, and a reference channel for capturing light in a frequency range different from the luminescence frequency range.

The test system has two separate subsystems, an analyte detection subsystem and a test verification subsystem. The analyte detection subsystem is configured to detect the presence of an analyte in a sample that is arranged in the measuring chamber, and the test verification subsystem is configured to detect invalid or unreliable tests. In particular, the test verification subsystem is configured to process the time series of light sensor output signals representing captured light intensities for determining whether the test performed with the detection device is valid or invalid. The two subsystems may share common components, for instance common detection and/or signal processing means.

The invention includes the insight that for solving the shortcomings of internal positive controls in isothermal amplification diagnostics (like RPA and its combinations with RT), it is possible to record and analyze additional optical variables in the course of the test reaction to distinguish use of proper reagents from inappropriate biochemistry and follow characteristic steps of user handling due to the dynamics of signals. The concept gives a less experienced user specific guidance. In addition, the concept excludes unsuccessful test runs before a diagnostic result is calculated.

Typically, RPA and similar reactions are monitored by detecting a single wavelength (or a small continuous band of wavelengths that can be detect by a luminescence channel of a light sensor) and plotting its intensity over time for diagnostic evaluation. Similarly, a separate second wavelength can be applied to the second fluorophore in a duplex test system. Also, in these systems only the “clean” curve after complete homogenization of all reagents are analyzed. However, the combination of a parallel multi-channel intensity recording with extension of data assessment to early stages of test phase (e.g. integrated, standardized preparation, mixing, tempering, and formation of supermolecular structures) with advanced data analytics (e.g. machine learning and/or artificial intelligence, in particular by means of neural networks) can be used to detect further characteristic patterns in the course of the diagnostic test. These additional data allow applying quality assessment analytics on a statistical level without the need for a second probe (as in a duplex system).

In a preferred embodiment, the analyte detection subsystem is configured to detect the presence of an analyte in a sample that is arranged in the measuring chamber by comparing the magnitude of an output signal of light sensor that is sensitive for light in caused by luminescence. If the detection system is configured to illuminate a sample contained in a test chamber of a container such as a cuvette or vial using light having wavelengths that can cause luminescence in case the sample contains a target analyte, the light sensor will put out a signal indicating a higher light intensity in case luminescence occurs and indicating a lower or no intensity, if no luminescence occurs. Accordingly, the analyte detection subsystem can be configured to compare the output signal of the light sensor that can sense luminescence (hereinafter also called “luminescence light sensor”) with one or more thresholds. The analyte detection subsystem can, for instance, be configured to indicate a positive test result if the time series of the output signal of the luminescence channel of the light sensor first falls below a first threshold and within a given time period thereafter exceeds a second, higher threshold, said higher threshold being adapted so it is only exceeded in case of luminescence, indicating a positive test result.

In a preferred embodiment, the test verification subsystem is configured to evaluate the time series of one or more output signals of one or more sensors. The evaluation can include an analysis of the time series of the light sensor(s) output signal(s) and may include an analysis of derivatives of signal curves generated from the time series of one or more output signals and a comparison output values and/or the signal curves with various thresholds. The analysis may also include a determination of signal ratios and the comparison of signal ratios with threshold values or reference ratios. In particular, the analysis may include a determination of signal ratios between the output signals of two different channels that are recorded and/or sampled simultaneously. Preferably, the analysis includes a determination of signals ratios of the output signal of the luminescence channel (herein also called luminescence signal) and of the output signal the reference channel (herein also called reference signal).

In preferred embodiments, the test verification subsystem is configured to determine an inappropriate environment temperature or a wrong sample volume or an adverse presence of bubbles or a combination thereof and to generate a verification subsystem output signal that can trigger a warning signal to a user. In particular, the test verification subsystem can be configured to determine turbidity by analysing the time series of the light sensor(s) output signal(s). Turbidity causes scattering of light and can be influenced by a wrong sample volume or disturbances like bubbles in the sample.

In another preferred embodiment, the test verification subsystem comprises a trained neural network, in particular a deep neural network having an encoder-decoder structure. The neural network can be configured as a classifier that is trained to discriminate input data sets representing valid tests from input data sets representing invalid tests. In particular, the neural network can be configured as a binary classifier generating an output signal that represents the probability that an input data set represents a valid test. In further preferred embodiments, the neural network can be configured as a multi classifier that generates outputs representing probabilities for different kinds of failed tests, e.g. for failed tests due to lacking test enzymes or for failed test due to a wrong sequence of actions performed by user etc.

The trained neural network can be trained with data representing time series of light sensor output signals for correct and for incorrect sample volumes and/or for an absence or an adverse presence of bubbles in the sample.

The neural network may have a multi-head architecture with a common encoder and differently trained decoders that will receive feature vectors or feature tensors from the common encoder.

The analyte detection subsystem and/or the test verification subsystem can be implemented by a device or a server that is physically separated from the test device.

In particular, the test device may simply comprise sensors, a controller and a data interface (in particular a wireless data interface) that are configured to transmit raw data representing sample values that in turn represent the time series of the light sensor signal(s) to an external device, for instance a mobile external device such as a smartphone or a tablet computer.

In another embodiment, the trained neural network is a regressing neural network (as opposed to a classifying neural network) that is trained to determine an environment temperature from the time series of the output signal(s) of the light sensor(s).

According to one aspect of the invention, the test system comprises a detection device, an analyte detection subsystem and a test verification subsystem. The detection device comprises a detection chamber and at least one light sensor for recording and/or sampling of light intensities of light in different frequency ranges over time. Accordingly, the light sensor preferably comprises at least two channels, a first channel for a first frequency range and a second channel for a second frequency range. Preferably the first channel is a luminescence channel for a frequency range where luminescence is expected in case of a positive test for an analyte. Preferably the second channel is a reference channel for a frequency range that is different from the where luminescence is expected in case of a positive test for an analyte.

The analyte detection subsystem is configured to detect the presence of an analyte in a sample that is arranged in the detection chamber. The test verification subsystem being configured to process the time courses of light intensities for detecting test parameter values that can render a test invalid. Test parameter values can be environment temperature, sample volume or the presence of test chemistry in the detection chamber.

Preferably, the light sensor of the detection device has at least two channels, a luminescence channel for capturing light in a luminescence frequency range in which luminescence occurs in case an analyte to be detected is present, and a reference channel for capturing light in a frequency range different from the luminescence frequency range.

Preferably, the verification subsystem is configured to generate normalized raw signal curves from the time series of the light sensor output value time series for the reference channel and/or the luminescence channel. It is further preferred if the verification subsystem is configured to compare the raw signal curves with upper and lower threshold values and to trigger a warning signal in case a signal curve exceeds the upper threshold value or falls below the lower threshold value.

According to another aspect of the invention, the detection device comprises a detection chamber, at least one light source, at least one light sensor and a control/evaluation unit. The light source is configured and arranged to illuminate the detection chamber) at least in part, The light sensor is arranged to detect and record light in the detection chamber. The light source, the light sensor and the detection chamber are configured and arranged so as to prevent light emitted from the light source from directly impinging the light sensor. The light sensor has a luminescence channel and a reference channel for recording light in at least two different ranges of wavelengths (i.e. light bands or color channels) and providing at least two time series of output signals, each time series of output signal representing the time course of an intensity of light in a respective range of wavelength. The control/evaluation unit is adapted to control recording of the at least two output signals of the light sensor. The detection device comprises or is connected to two separate subsystems, an analyte detection subsystem and a test verification subsystem. The analyte detection subsystem is configured to detect the presence of an analyte in a sample that is arranged in the detection chamber. The test verification subsystem is configured to process the time series of output signals that represent the time courses of light intensities for detecting test parameter values that can render a test invalid.

In a preferred embodiment, the test verification subsystem comprises a trained neural network.

Preferably, the trained neural network is a classifying neural network that is trained with training data sets that each represent at least one time series of output values produced in a testing procedure that was verified as being valid. Preferably, the trained neural network is a classifying neural network that is trained with training data sets that each represent at least two time series of output values produced in a testing procedure that was verified as being valid, a first time series representing raw output values of a luminescence channel of the light sensor and a second time series representing raw output values of a reference channel of the light sensor.

Preferably, the test verification subsystem is configured
to generate normalized raw signal curves from the time series of the light sensor output value time series for the reference channel and/or the luminescence channel and
to compare the raw signal curves with upper and lower threshold values and to trigger a warning signal in case a signal curve exceeds the upper threshold value or falls below the lower threshold value.

Preferably, the analyte detection subsystem is configured to determine a ratio between the output values for a first range of wavelengths and the output values for a second range of wavelengths, the first range of wavelengths being captured by a luminescence channel of the light sensor and the second range of wavelengths being captured by a reference channel of the light sensor. In addition, the analyte detection subsystem may be configured to determine whether the ratio between the output values for a first range of wavelengths and the output values for a second range of wavelengths exceeds a predetermined threshold.

According to yet another aspect, a method of operating a testing system comprises:
time sampling light-intensity values in at least two different regions of wavelengths (light channels) by means of a light sensor that produces output values reflecting sampled light intensity values and generating at least two time series of output values therefrom,
generating light intensity curves from the time series of the output values of the light sensor, and
analyzing the light intensity curves by comparing the light intensity curves with predetermined threshold values.

Preferably, the method comprises:
time sampling light-intensity values in at least two different regions of wavelengths (light channels) by means of a light sensor that produces output values reflecting sampled light intensity values and generating at least two time series of output values therefrom,
forwarding data sets (tensors) representing the at least two time series of output values to a trained neural network
using the output signal of the trained neural network for triggering or inhibiting a warning signal.

Preferably, the trained neural network is a classifying neural network that is trained with training data sets that each represent at least one time series of output values produced in a testing procedure that was verified as being valid.

Preferably, the trained neural network is a classifying neural network that is trained with training data sets that each represent at least two time series of output values produced in a testing procedure that was verified as being valid, a first time series representing raw output values of a luminescence channel of the light sensor and a second time series representing raw output values of a reference channel of the light sensor.

Further aspects of the test system and its method of operation are:
recording and analysis of the time series of recorded and/or sampled light signals recorded and/or sampled in the course of the test reaction to distinguish use of proper reagents from inappropriate biochemistry
record the intensities in two or more light “channels” (frequency ranges) in parallel
detection, recording and analysis of sequences of user actions, preferably already during preparation of a sample
use machine learning (trained neural network) for quality assessment to discriminate valid and invalid tests

The invention shall now further be illustrated by way of an example and with a reference to the figures. Of the figures,

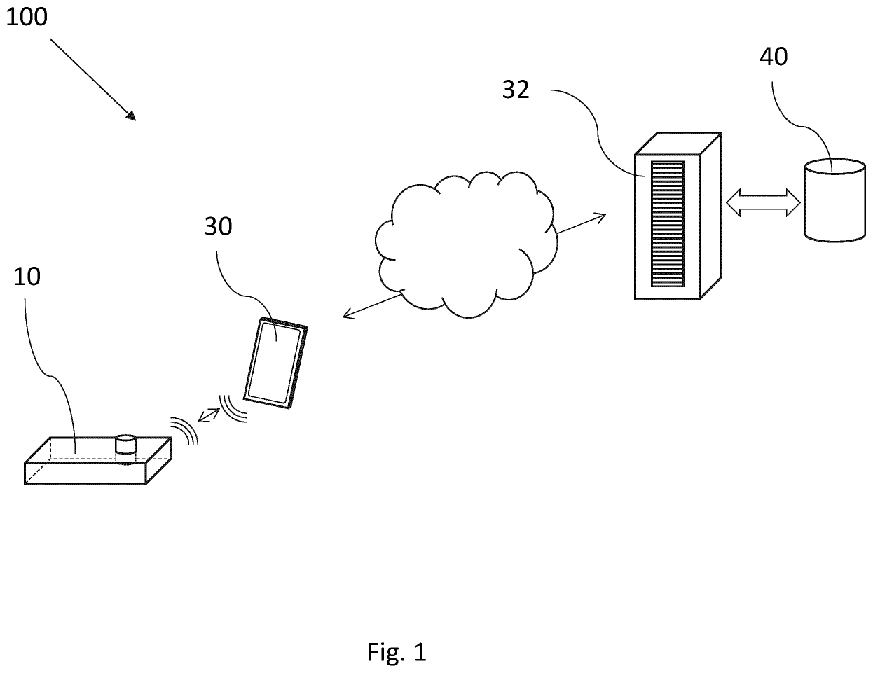

FIG. 1: illustrate a test system comprising detection device, an external device and a server;

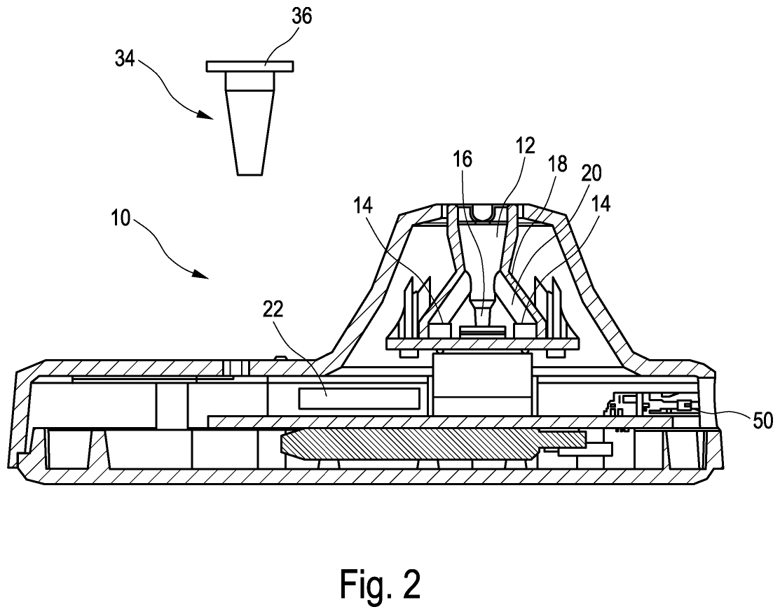

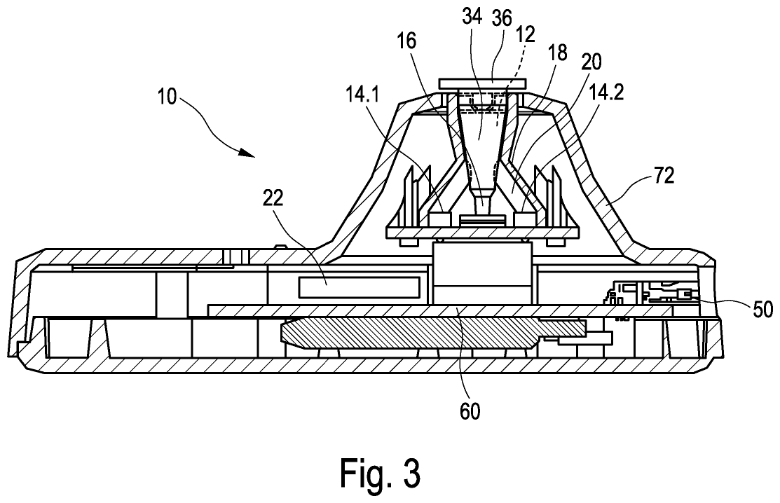

FIGS. 2 and 3: show a detection device for detecting a target analyte by way of registering light in a detection chamber;

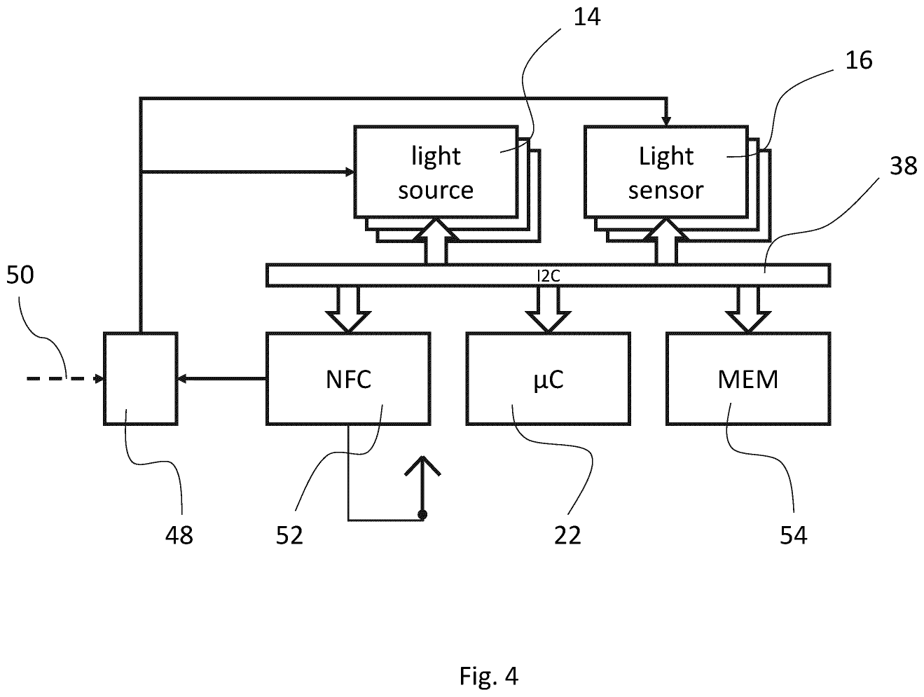

FIG. 4: is a simplified block diagram of some components of the detection device of FIGS. 2 and 3;

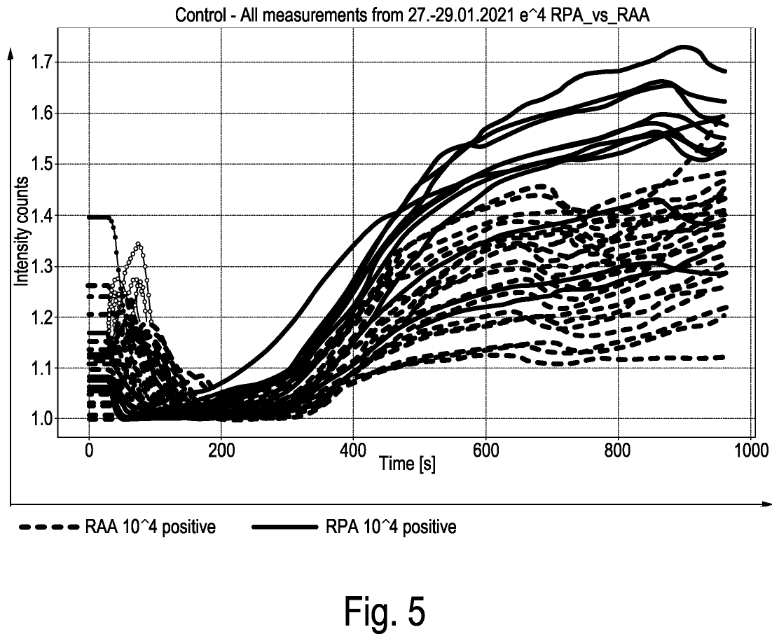

FIG. 5: show the time course of light intensity detected by a multi-channel light sensor of the detection device of FIGS. 1 to 4;

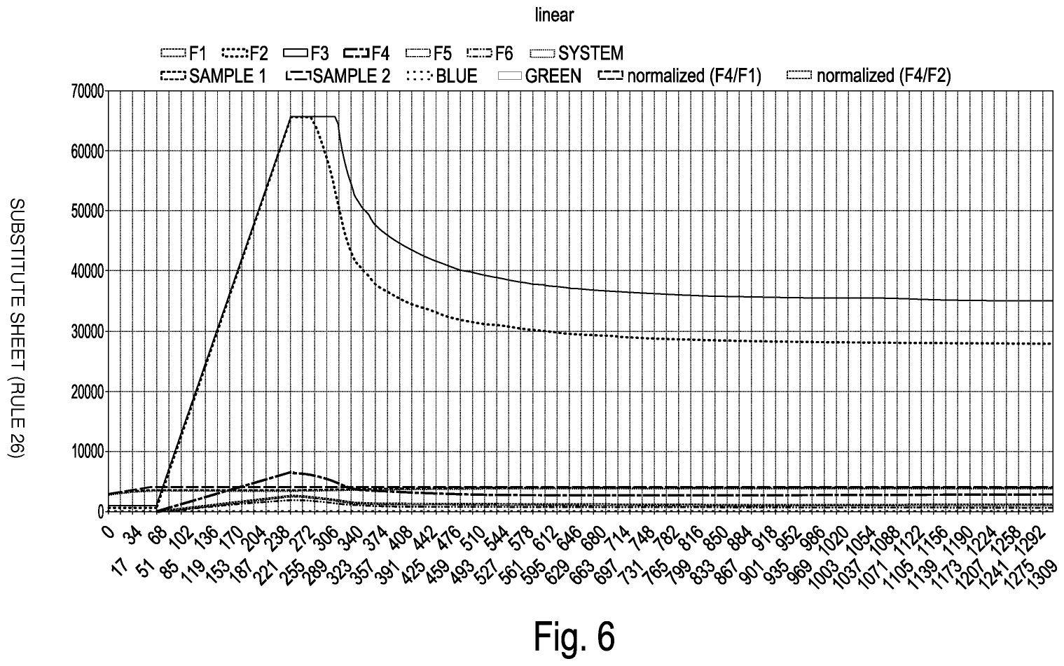

FIG. 6: illustrates the time course of light intensities captured for different wavelengths in an initial phase of a test prior to detection of luminescence for a valid test;

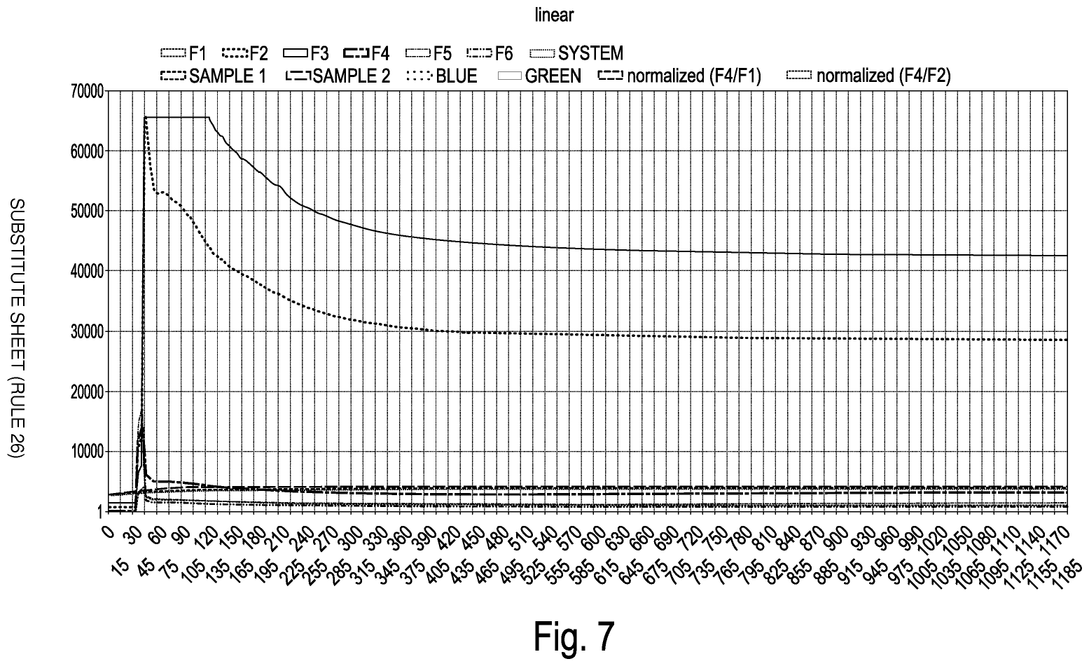

FIG. 7: illustrates the time course of light intensities captured for different wavelengths in an initial phase of a test prior to detection of luminescence for an invalid test;

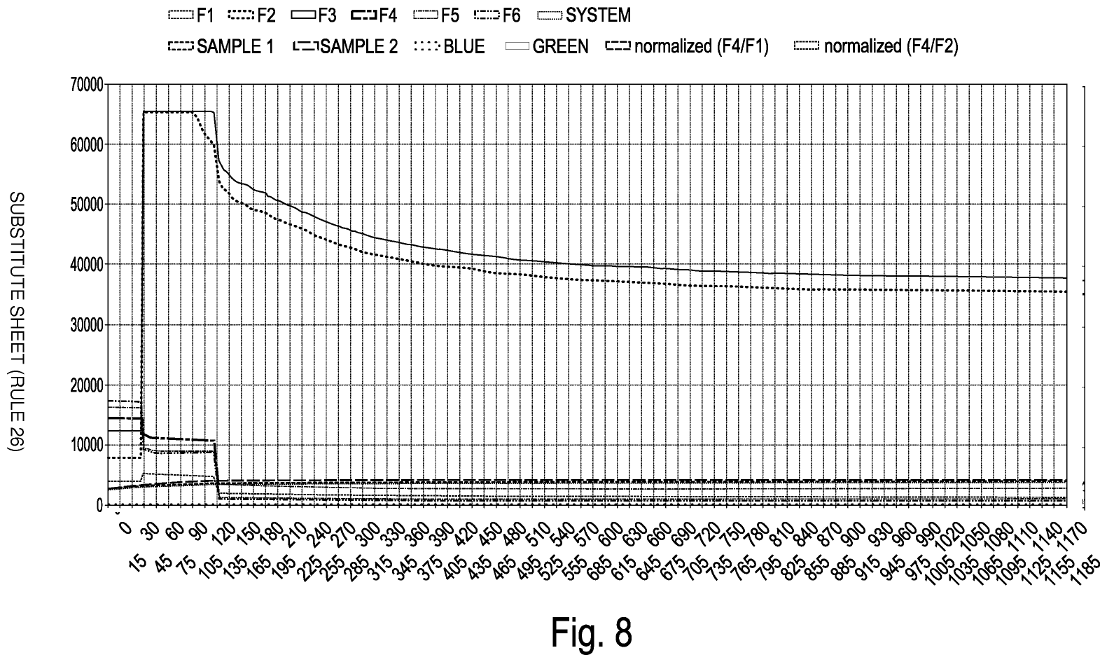

FIG. 8: illustrates the time course of light intensities captured for different wavelengths in an initial phase of a test prior to detection of luminescence for another kind of invalid test;

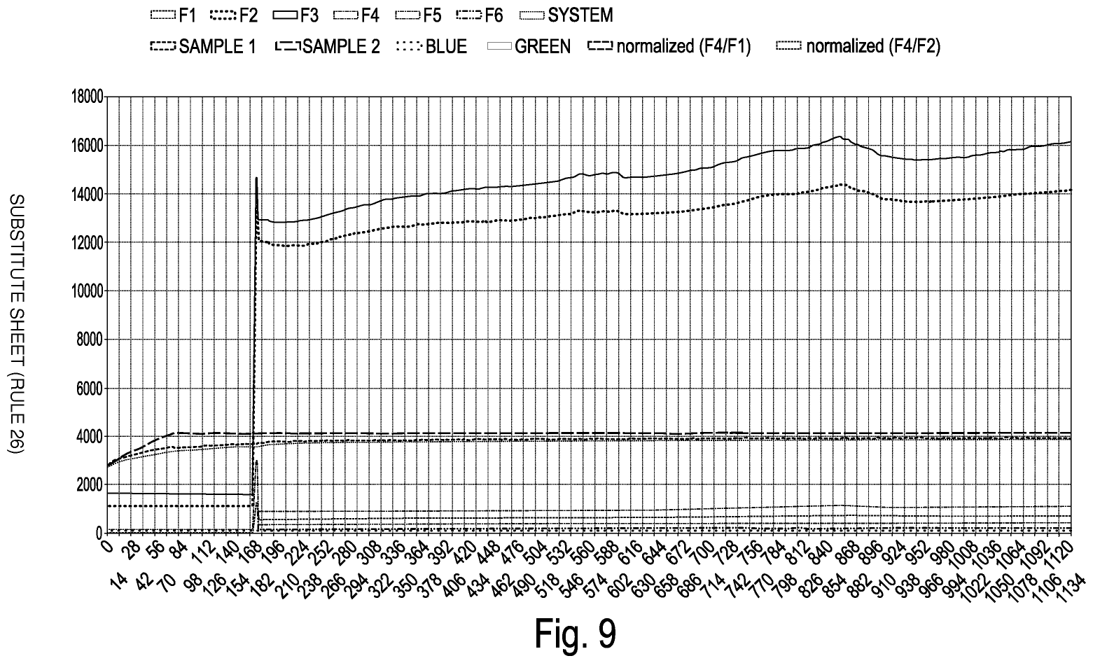

FIG. 9: illustrates the time course of light intensities captured for different wavelengths in an initial phase of a test prior to detection of luminescence for a third kind of invalid test;

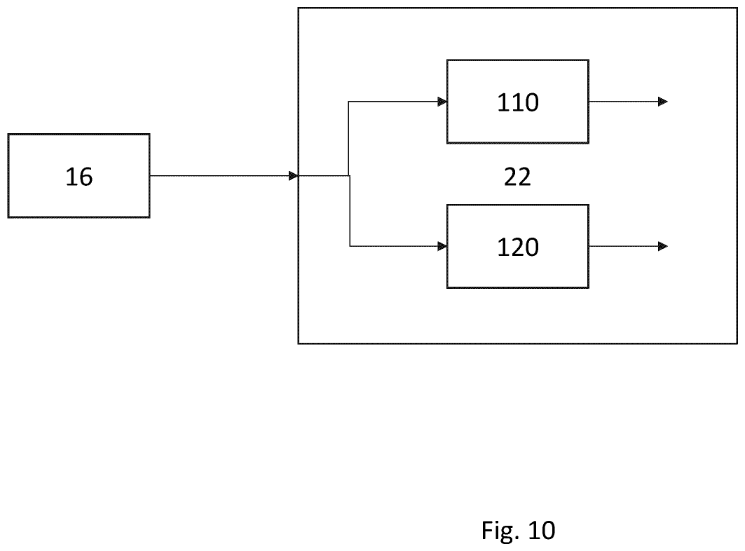

FIG. 10. is schematic block diagram illustrating a control unit implementing an analyte detection subsystem and a test verification subsystem;

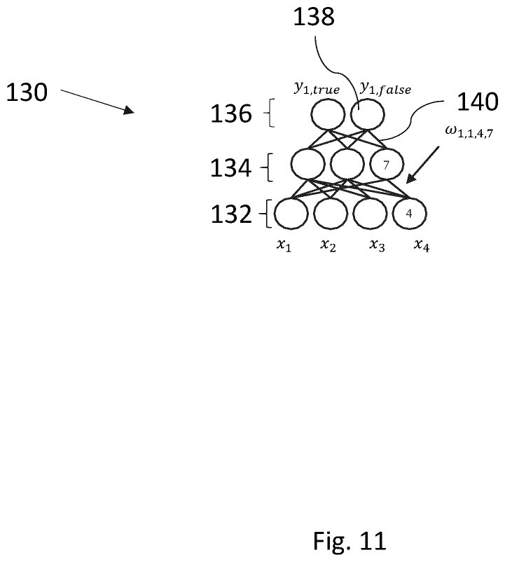

FIG. 11: illustrates a neural network used in a test verification subsystem;

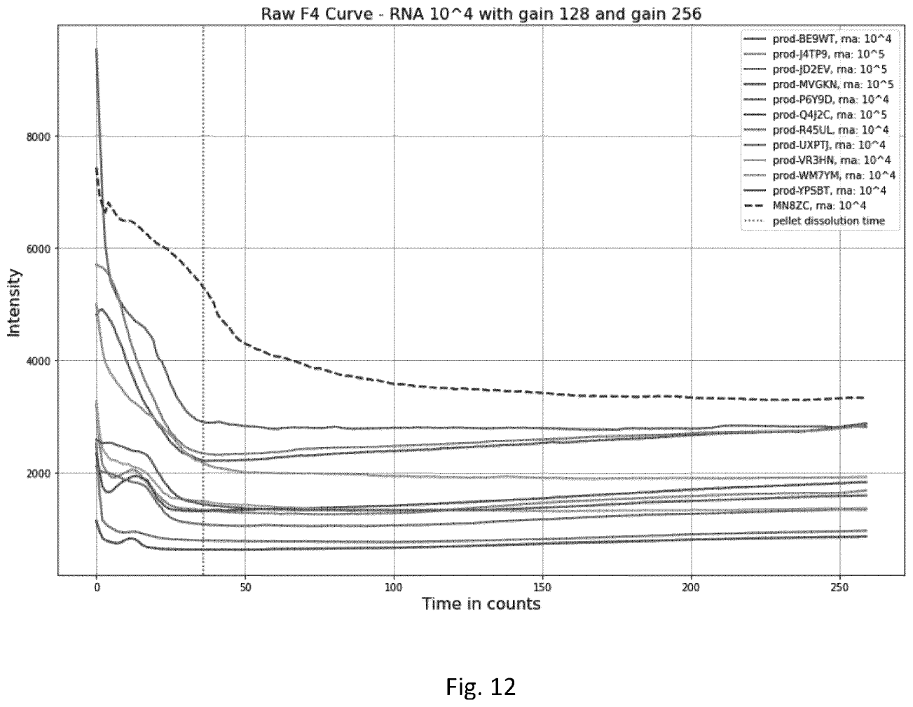

FIG. 12: time curves of light sensor output signals (raw data) for the luminescence channel for different sample volumes prior to normalizing;

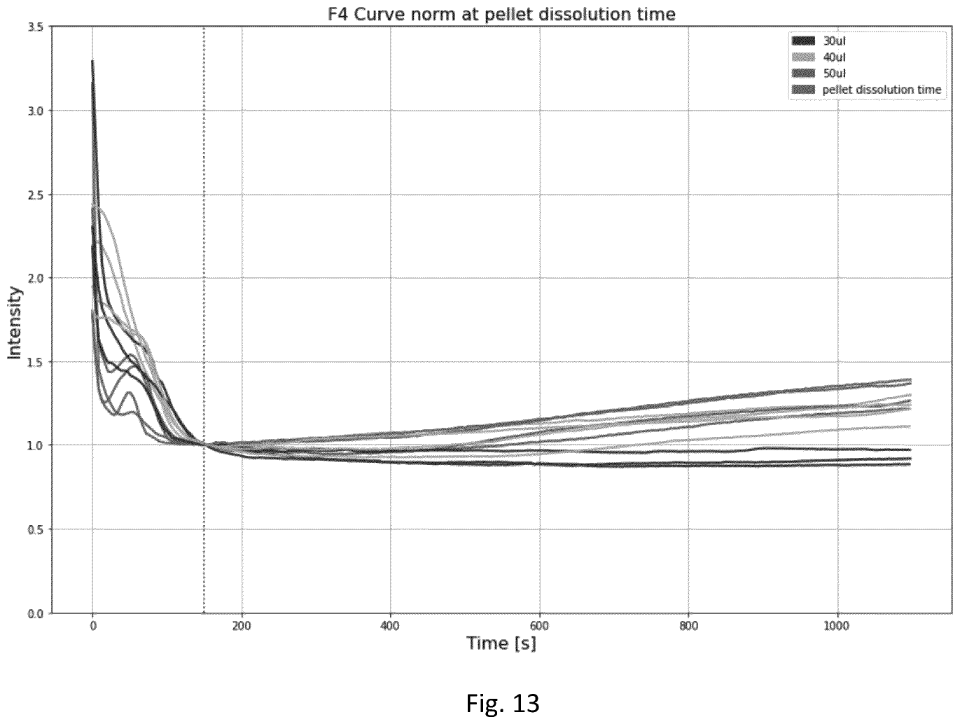

FIG. 13: time curves of light sensor output signals (raw data) for the luminescence channel normalized at pellet dissolution time for different sample volumes;

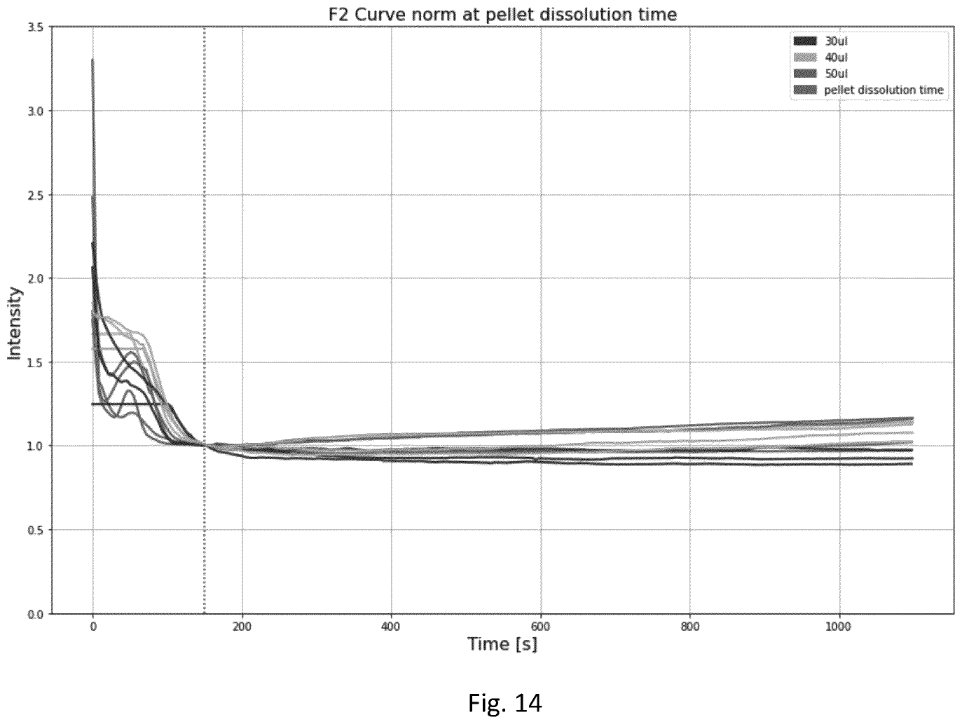

FIG. 14: time curves of light sensor output signals (raw data) for the reference channel normalized at pellet dissolution time for different sample volumes;

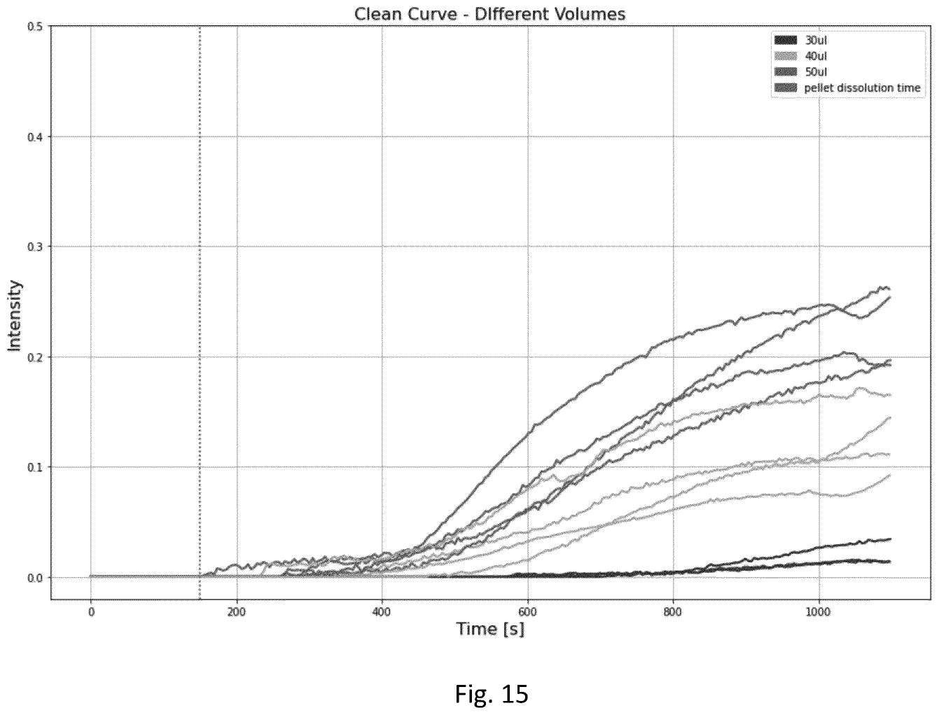

FIG. 15: time curves of processed light sensor output signals for different sample volumes;

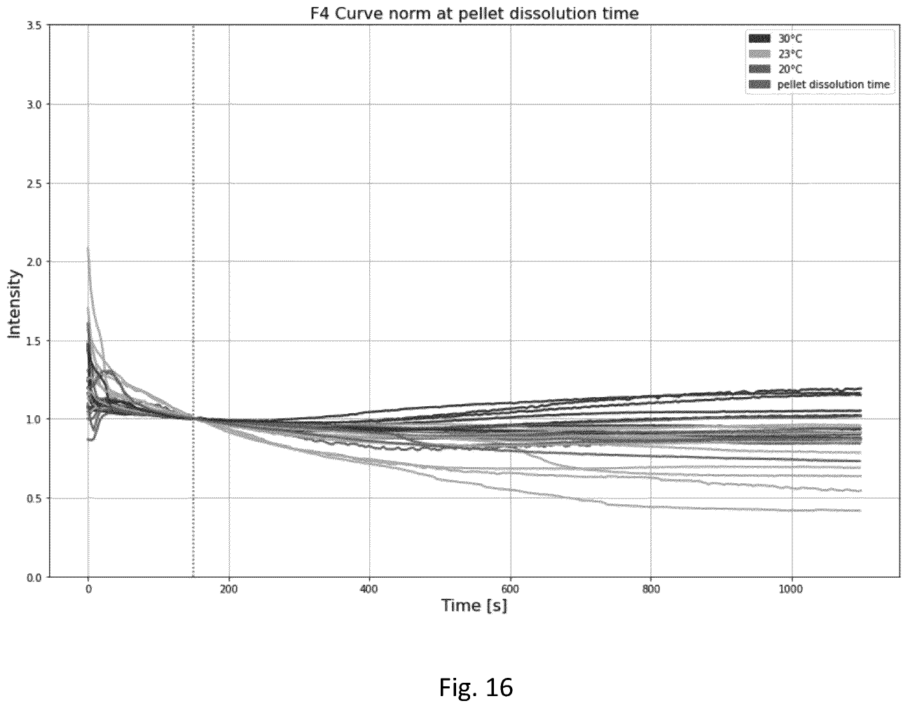

FIG. 16: time curves of light sensor output signals (raw data) for the luminescence channel normalized at pellet dissolution time for different environment temperatures;

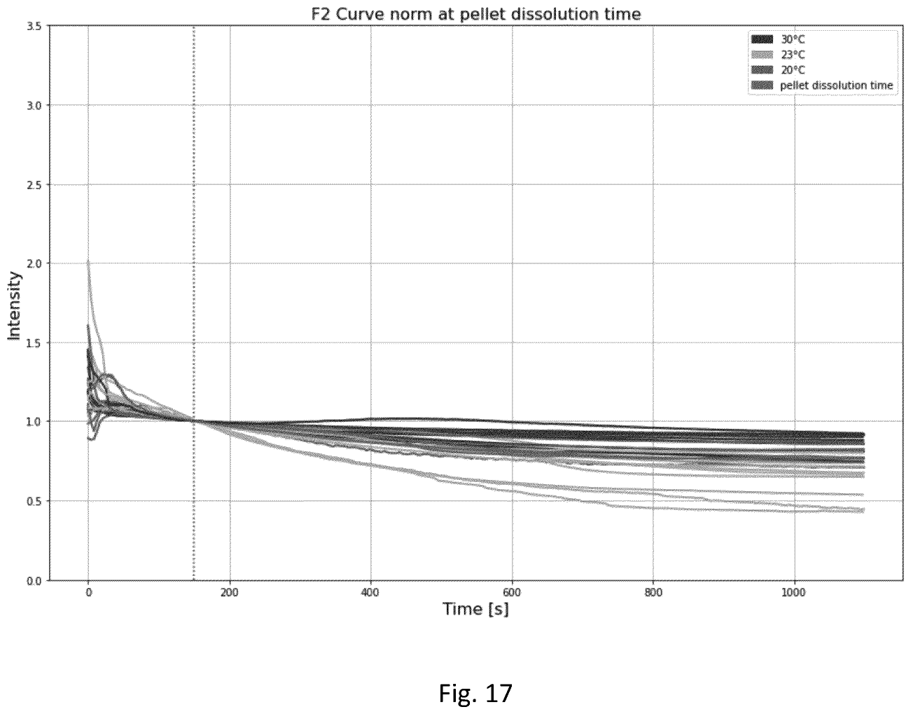

FIG. 17: time curves of light sensor output signals (raw data) for the reference channel normalized at pellet dissolution time for different environment temperatures; and

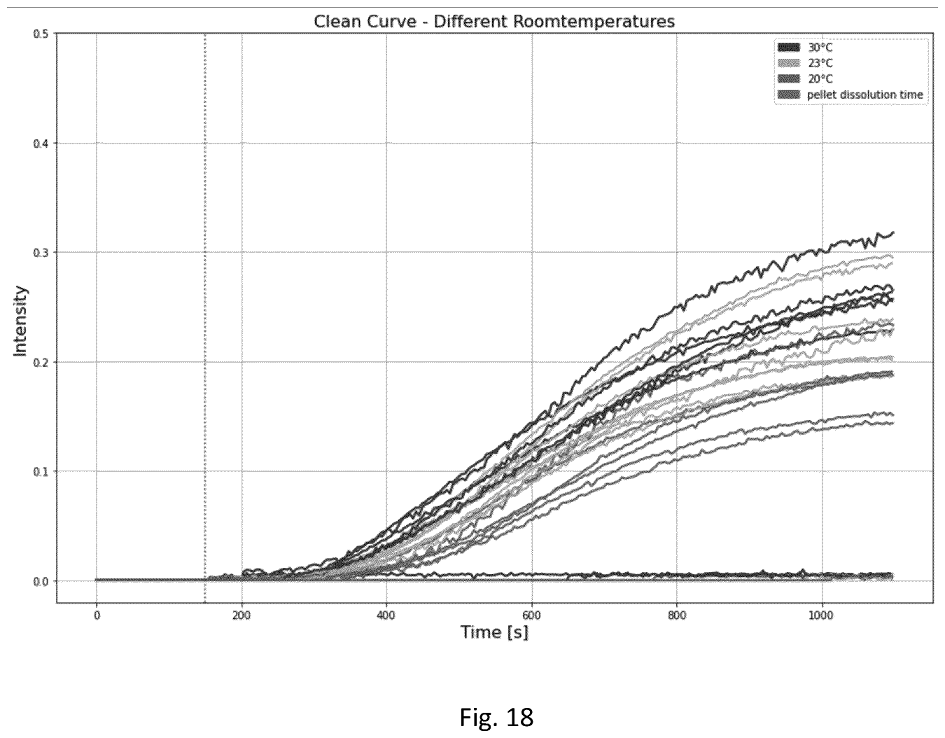

FIG. 18: time curves of processed light sensor output signals for different environment temperatures.

A test system 100 comprises at least one detection device 10. In its simplest form the test system is implemented in a single detection device. The test system 100 may further comprise an external device 30 and a server 32; cf. FIG. 1.

Detection device 10 for detecting a target analyte has a detection chamber 12 that can receive a vial or cuvette 34; see FIGS. 2 and 3. The cuvette 34 has transparent walls that enclose a test chamber. In the test chamber of the cuvette 34 a mixture of enzymes for recombinase polymerase amplification comprising a recombinase, a single-stranded DNA-binding protein (SSB), a strand-displacing polymerase, exonuclease iii and in case RNA is to be detected, a reverse transcriptase. By this mixture of enzymes a target analyte, in particular a nucleic acid such as DNA or RNA can be amplified in a sample by way of recombinase polymerase amplification (RPA). For detecting the presence of a target nucleic acid in a sample, fluorescence detection technique can be used. After a light source 14 at specific wavelength illuminates the target nucleic acids, the DNA-binding dyes or fluorescence-binding probes of the nucleic acid will react and enable fluorescent signals to be emitted. The fluorescent signal is an indication of the existence of the target nucleic acids.

To illuminate the probe in the test chamber of the cuvette 34, detection device 10 comprises light sources 14.1 and 14.2 and a light sensor 16. The walls 18 enclosing the detection chamber 12 are opaque. Illuminating light emitted by light sources 14 can pass along light passes 20 to illuminate the sample in the test chamber of the cuvette 34 through the transparent walls of the cuvette 34. Any light emitted or scattered by the sample in the test chamber of the cuvette 34 can be registered by light sensor 16. The light passages 20 prevent the light emitted by light sources 14.1 and 14.2 from directly impinging on light sensor 16.

Light sources 14.1 and 14.2 preferably are light emitting diodes (LEDs) that can emit light with different wavelengths.

Light sensor 16 is a multichannel light sensor that is capable of registering light in different light bands (wavelength ranges) simultaneously. The different light bands are also called “channels” or “color channels” in this description. For each channel, light sensor 16 can generate an individual light sensor output signal reflecting the intensity of the light captured by the light sensor 16 in a particular range of wavelengths (i.e. light band). For example, light sensor 16 may be capable to record four, six or eight light bands (channels) simultaneously. Light sensor 16 is connected to a control unit 22. Control unit 22 is configured to record and store the output signals provided by light sensor 16 over time. Thus, control unit 22 can generate data that represents the intensity of light recorded by light sensor 16 over time for each channel separately. Thus, for instance six different curves can be recorded that represent the intensity of the light in six different light bands, i.e. in six different wavelength ranges. For each channel, the light sensor 16 generates an output signal that represents the intensity of the light captured by light sensor 16 in a light band over the time. The temporal course of the light signal is put out as a time series of sampled intensity values.

The light sensor 16 has at least two channels, a luminescence channel for capturing light in a luminescence frequency range in which luminescence occurs in case an analyte to be detected is present, and a reference channel for capturing light in a frequency range different from the luminescence frequency range.

In FIG. 4, a simplified block diagram illustrates some functional components of the detection device 10.

Within the detection chamber 12 or adjacent to the detection chambers 12 light sources 14.1 and 14.2 and at least one light sensor 16 are arranged. Each light source 14.1 and 14.2 is configured to illuminate the contents of the detection chamber 12, respectively, with a light that can cause luminescence in a sample to be tested during and after the sample has undergone recombinase polymerase amplification. The light sensor 16 is arranged and configured to detect luminescence in the respective detection chamber 42 in case luminescence occurs. A further light sensor with different sensitivity or arrangement may be provided in addition. The light sensor 16 is an optical sensor that may be a multispectral sensor providing different output signals for different light spectra, i.e. different channels. Accordingly, in FIG. 4, a plurality of light sensors are shown since a multispectral sensor acts like multiple sensors.

The light sources 14.1 and 14.2 and the light sensor 16 preferably are configured to emit and sense, respectively, light having a bandwidth for causing luminescence and at least one further bandwidth.

For powering up the light sources 14.1 and 14.2 and the light sensor 16, an energy supply 48 is provided. The energy supply 48 may comprise a battery, preferably a rechargeable battery. Alternatively or additionally, energy supply 48 may comprise a power interface 50 for connecting the luminescence, preferably the fluorescence detection device 16 to an external power supply. The power interface 50 may be wire-bound or wireless, for instance a USB interface. The energy supply 48 may also comprise solar cells for providing photovoltaic power supply.

The light sources 14.1 and 14.2 and the light sensor 16 are further connected to the controller 22 that is configured to control the operation of the light sources 14.1 and 14.2 and the light sensor 16 and to further read out a sensor output signals provided by the light sensor 16. Controller 22 can be a microcontroller or a state machine.

The controller 22 is operatively connected to a wireless data interface 52 that is configured to allow for a data communication between the microcontroller 22 and an external device such as a mobile phone or another device for data communication and data processing.

Preferably, the wireless data interface 52 is operatively connected to the controller 22, to the energy supply 48 and to a data memory 54 and is configured to provide for energy harvesting data storage and data communication. In particular, the wireless data interface 52 implements means for near field communication (NFC) and comprises a data bus such as an I2C data bus 56 for communication with the controller 22. The wireless data interface 52 preferably is configured to allow bidirectional data communication so as to transmit data generated by the luminescence, preferably by the fluorescence detection device 10 to an external device 30 and to receive the control commands and/or software updates from an external device 30 so that the luminescence, preferably the fluorescence detection device 16 can be controlled and updated by way of an external device 30.

The wireless data interface 52 may also implement WiFi-communication as an alternative to near field communication. Another alternative is Bluetooth-communication.

Preferably, all electronic components that implement the wireless data interface 52, the controller 2 and the data memory 54 are arranged on a flat printed circuit board 60. The flat printed circuit board 60 can be part of a laminated card wherein the electronic components are arranged between two laminated cover sheets. Alternatively, in other embodiments, the printed circuit board can be flexible, semi-flexible or a rigid-flexible board. The printed circuit board may be a conventional circuit board or a circuit board manufactured by printing or other additive methods, or combinations thereof.

Optionally, heating means can be provided. The heating means may comprise an electric heating that is integrated into the luminescence, preferably into the fluorescence detection device 10 and that can heat the cuvette 34 and its contents to thus start and/or promote the amplification process. Preferably, the luminescence, preferably the fluorescence detection device 10 is configured to automatically start electric heating one the cuvette 34 is inserted into the detection chamber 12. The insertion of the cuvette 34 can be detected by means of a dedicated sensor, for instance a switch, or by means of the optical sensor 16. In particular, the light sensor 16 can sense that the assembly is inserted into the detection chamber 12 because the collar 36 prevents external light from entering the detection chamber 12 once the assembly is inserted in the detection chamber 12. Accordingly, insertion of the cuvette 34 into the detection chamber 12 causes a drop in light intensity sensed by the light sensor 16. Such drop in light intensity can be detected and can cause a starting signal for the electric heating.

Alternatively or additionally, the heating means may be provided by chemicals in the cuvette 34 that undergo an exothermal reaction once a sample is filled in the cuvette 34.

Alternatively or additionally, the heating means may be provided by chemicals that undergo an exothermal reaction once a sample is introduced into the receptacle. These chemicals are arranged in proximity of the detection chambers 12, in a separate sealed arrangement that contains the heating chemicals. Upon a trigger, the exothermic chemical reaction is started. This can be suitable when the system is used, for example, as a portable diagnostic tool.

Another alternative that allows heating of the luminescence detection device, preferably the fluorescence detection device is proving a dark colour, for instance black, on the outside of the fluorescence detection device. Thus, for example, a fluorescence detection device together with the amplification chamber can be solar heated. Preferably, temperature control means are provided that indicate potential overheating of the fluorescence detection device together with the amplification chamber. The temperature control means may comprise an ink or paint that changes its colour in case a predefined temperature is exceeded. Accordingly, an indicator that changes its colour at a certain temperature and that is applied to the outside of the fluorescence detection device may be a temperature control means.

The detection chamber 12 is arranged in a detection chamber housing 72 that has outer dimension smaller than 10 cm by 10 cm by 4 cm. Preferably, the volume of the entire luminescence, preferably of the fluorescence detection device 16 is smaller than 200 cm², and even more preferred smaller than 100 cm². In a preferred embodiment, the longest outer dimension is a least twice as long as the shortest outer dimension.

FIG. 5 is an example of intensity curves recorded by light sensor 16. The light recorded by light sensor 16 comprises light emitted by the sample due to luminescence. Further, light is scattered by the sample and thus scattered light is recorded by light sensor 16.

Prior to placing a cuvette 34 in the detection device 10, a sample is prepared to cause an amplification of the target analyte in the cuvette. Sample preparation may include lysing of a sample taken from an individual and using a pipette to put a defined volume of the lysed sample in the cuvette that contains a mixture of enzymes for target analyte amplification.

After placing the cuvette with the sample into the detection chamber, in an initial phase, light is recorded by the light sensor 16 because light emitted by light sources 14.1 and 14.2 is straying due to inhomogeneities in the fluid in the cuvette 34. In a typical application, these inhomogeneities slowly disappear. Thus the light intensity recorded by the light sensor 16 decreases due to less stray light. Once the amplification occurs and proceeds, in a positive test increasing luminescence occurs leading to an increasing light intensity recorded by light sensor 16. This can be seen in FIG. 5 where the time course of the light intensity recorded by a light sensor 16 over time is depicted.

The detection device 10 may comprise heating means to promote the amplification of target analytes in the cuvette 34.

A test procedure may require the following user actions:
Start the detection device and wait until it is ready (preheating done)
Sample Preparation
Insert the cuvette, (close the cap,) and start the test

The shape of the curves provided by each channel of light sensor 16 (i.e. the output signal for the different light bands the sensor can sense and discriminate) depends on the course of the reaction and also depends on user interactions. User interactions for example can be detected because the light registered by light sensor 16 changes when a cuvette is inserted in detection chamber 12 or removed from detection chamber 12. Accordingly, it is possible to determine the time when a cuvette is inserted in detection chamber 12. Then, the time series of the sensor signals can be followed. Emission of light by the sample in the cuvette is not equal for all wavelengths. For example, light having a shorter wavelength is scattered more than light with a longer wavelength. Since the emission of light by the sample in the cuvette depends on the mixture of enzymes in the cuvette and on the course of the reaction, it is possible to not only detect the presence of luminescence in the probe but also to verify a proper course of the reaction by analyzing the time series of the signals provided by light sensor 16.

FIGS. 6, 7, 8 and 9 illustrate the time series of light intensities (as reflected by the output signals of light sensor 16 over the time) captured for different wavelengths in an initial phase of a test prior to detection of luminescence. The time series of intensities as illustrated in FIG. 6 reflects a correct handling of the test by a user.

The correct handling leads to the following sequence of events:
Cap is closed
Device is turned on, preheating starts
Preheating is done
Some waiting time
Cap is opened and cuvette is inserted
Cap is closed
Test starts

The time series of light intensity values (processed light sensor output values) as illustrated in FIG. 7 reflects a wrong handling of the test by a user, leading to the following sequence of events:
Cap is closed
Device is turned on, preheating starts
˜45 seconds from when the device is turned on,
Cap is opened and cuvette is inserted
Cap is closed
Preheating is done
Test starts (immediately with no waiting time)

The time series of light intensity values (processed light sensor output values) as illustrated in FIG. 8 reflects a wrong handling of the test by a user, leading to the following sequence of events:
Cap is closed
Device is turned on, preheating starts
Cap is opened
˜105 seconds from when the device is turned on,
Cuvette is inserted
Preheating is done
Test starts (immediately with no waiting time)
Cap is closed

The time series of light intensity values (processed light sensor output values) as illustrated in FIG. 9 reflects a wrong handling of the test by a user, leading to the following sequence of events:
Cap is closed
Device is turned on, preheating starts
User has the cap on with no cuvette inside device
Preheating is done
Test starts (immediately with no waiting time)
˜180 seconds from when the device is turned on,
cap is opened and cuvette containing only water is inserted
Cap is closed

The test system 100 comprises an analyte detection subsystem 110 and a test verification subsystem 120; see FIG. 10. Both subsystems 110 and 120 are provided with the output signals of sensor 16 and thus receive signals that represent the temporal course of light intensities in different light bands as shown in FIG. 2. In particular, both subsystems 110 and 120 receive the luminescence signals and the reference signals, i.e. the light sensor output signals for the luminescence channel and the reference channel, respectively. The curves represented by the time series of the luminescence signal and the reference signal, respectively, are analyzed by the analyte detection subsystem 110 and the test verification subsystem 120.

While the analyte detection subsystem 110 is configured to detect the presence or non-presence of an analyte in the probe by way of curve analysis and evaluation, the test verification subsystem is configured to analyze and evaluate the curves with respect to whether the test performed with the detection device 10 may reflect that a test parameter values is out of bounds and thus the test may be invalid.

In general, the analyte detection subsystem 110 is configured to detect the presence of an analyte in a sample that is arranged in the measuring chamber by comparing the magnitude of an output signals of light sensor that is sensitive for light in caused by luminescence. If the detection system 100 with detection device 10 is configured to illuminate a sample contained in a test chamber of a container such as the cuvette 34 with light having wavelengths that can cause luminescence in case the sample contains a target analyte, the light sensor 16 will put out a luminescence signal indicating a higher light intensity in case luminescence occurs and indicating a lower or no intensity, if no luminescence occurs. Accordingly, the analyte detection subsystem 110 can be configured to compare the output signal of the light sensor 16 that can sense luminescence (hereinafter also called “luminescence light sensor”) with one or more threshold. The analyte detection subsystem 110 can, for instance, be configured indicate a positive test result if the temporal course of the luminescence channel output signal of the luminescence light sensor 16 first falls below a first threshold and within a given time period thereafter exceeds a second, higher threshold, said higher threshold being adapted so it is only exceeded in case of luminescence.

In a preferred embodiment, the test verification subsystem 120 is configured to evaluate the development over time (i.e. the temporal course as reflected by the sampled output signal time series) of one or more output signals of one or more sensors 16. The evaluation can include an analysis of the time series and may include an analysis of derivatives of the time series and a comparison with various thresholds. The analysis may also include a determination of signals ratios and the comparison of signal ratios with threshold values or reference ratios. In particular, the analysis may include a determination of signals ratios between the time series of two different signals that are recorded and/or sampled simultaneously.

In another preferred embodiment, the test verification subsystem 120 comprises a trained neural network 130, in particular a deep neural network. The neural network can be configured as a binary classifier that is trained to discriminate input data sets representing valid tests from input data sets representing invalid tests. In particular, the neural network 130 can be configured as a binary classifier generating an output signal that represents the probability that an input data set represents a valid test. In further preferred embodiments, the neural network can be configured as a multi classifier that generates outputs representing probabilities for different kinds of failed tests, e.g. for failed tests due to lacking test enzymes or for failed test due to a wrong sequence of actions performed by user etc.

The analyte detection subsystem and/or the test verification subsystem can be implemented by the controller of the detection device 10 or the server 32 that is physically separated from the detection device 10. In the latter case, the external device 30 can act as a relay device for enabling a data transfer between a detection device 10 and a server 32.

In particular, the detection device 10 may simply comprise sensors 16, a controller 22 and a data interface 42 (in particular a wireless data interface) that are configured to transmit raw data representing sample values that in turn represent the time series of the light sensor output signal(s) to an external device, for instance a mobile external device 30 such as a smartphone or a tablet computer. The external device 30 can link the detection device 10 to the server 32. Thus, preferably all data provided by sensors 16, not filtered, are fed to server 32. Thus, the test system 100 may benefit from aggregating data from different detection devices in a data base 40.

Data aggregated in data base 40 can be used to generate training data sets for training of at least one neural network 130 that is implemented by server 32.

The neural network 130 is composed of layers 132, 134 and 136. Layer 132, 134 and 136 are composed of nodes 138; see FIG. 11. Nodes 132, 134 and 136 have an input and an output. The input of a node 20 can be connected (see 140) to some or all outputs of nodes 20 in an anteceding layer thus receiving output values from the outputs of nodes of the anteceding layer. The values a node receives via its inputs are weighted and the weighted inputs are summed up to thus form a weighted sum. The weighted sum is transformed by an activation function of the node into the output of that node.

A first layer 132 is an input layer that receives a tensor with input data representing an input data set. A first layer 136 is an output layer. In case of a discriminator or a binary classifier, an output layer 136 has two output nodes 138. One output node 138 provides a value the represents the probability that data in a respective input data set belong to a valid test while the other output node represents a probability value that data in a respective input data set belong to an invalid test. Between the input layer 132 and the output layer 136 one or more hidden layers 134 may be provided.

The structure defined by the layers of a neural network-its topology or architecture-defined prior to training of a neural network

During training of a neural network 130 the weights in the nodes 138 of the layers 132, 134 and 136 of the neural network 130 are modified until the neural network provides the desired or expected prediction. If an input data set used for training the neural network represents data gathered with a valid test, the expected prediction is a high probability for “valid test”. Likewise, if an input data set used for training the neural network represents data gathered with an invalid test, the expected prediction is a high probability for “invalid test”. Pairs of input data sets and the expected prediction (also known as “label”) form a “ground truth” used for training a neural network. Typically, a neural network is trained with a huge number of input data sets for both classes, i.e. the “valid test”-class and the “invalid test”class.

The neural network thus learns to predict (e.g. recognize) classes of objects or features it is trained for. The parameters created during training of the neural network, in particular the weights for the inputs of the nodes, form a model. Thus, a trained neural network implements a model.

An input data set may comprise data representing the time series of the output signals of light sensor 16, for instance sampled light intensity values for different color channels. If the input data set is comprised of sample values representing time series of the output signals of sensor 16, these values may have the form of a tensor, e.g. a matrix. The number of nodes of the input layer of the neural network 130 corresponds to the number of elements of the tensor representing the time series of the output signals of sensor 16 plus potential further values, e.g. flags representing the state of the detection device at different points in time.

The training input data sets including the labels preferably are generated with a duplex test system that analyses a second probe comprising a second fluorophore as known in the art.

The test results for the second (duplex) probe are used as labels for labelling the training data sets thus forming the ground truth.

Preferably, sensor output signals are already recorded and/or sampled in pre-test phase prior to testing a sample to allow calibration.

In an alternative embodiment, the neural network can be trained and configured as a regressing neural network that for instance is trained to determine an environment temperature.

FIGS. 12, 13, 14 and 15 illustrate the effect of the sample volume on the light received by the light sensor 16 and thus on the light sensor output signals. Different sample volumes—for instance 30 μl or 40 μl instead of 50 μl as required-may result in change of turbidity that can be sensed by light sensor 16. It is noted that scattering resulting from (microscopic) turbidity, optical interfaces and/or environmental reflection is an inherent property of the sample system. Goal of our quality-assessment by the verification subsystem is to detect changes that are deviating from expectations, and such indicating wrong samples or wrong handling.

The relatively high intensities at the beginning of each curve are cause by light scattering when the pellet is not completely dissolved yet.

FIG. 12 shows the time series of the raw output signals of the luminescence channel of light sensor 16, i.e. the raw luminescence signal.

FIG. 13 shows the normalized time series of the raw output signals of the luminescence channel of light sensor 16, i.e. the raw luminescence signal. The time series are normalized at pellet dissolution time, i.e. at a point of time where the pellet was completely dissolved.

FIG. 14 shows the normalized time series of the raw output signals of the reference channel of light sensor 16, i.e. the raw reference signal. Again, the time series are normalized at pellet dissolution time. As can be seen from the curves, the effect of the sample volume can be seen in both, the luminescence channel (FIG. 13) and the reference channel (figure 14).

FIG. 15 shows the processed light sensor output signal. The processed reflects the ratio between the output signals of the luminescence channel and the output signals of the reference channel.

FIGS. 16, 17 and 18 illustrate the time series of light sensor output signals for different environment temperatures. Higher environment temperatures lead to higher intensities of luminescence and thus to higher light sensor output signals if other parameters such as sample temperature or heating energy otherwise are identical. Thus, the verification subsystem can detect when the environment temperature is out of bounds.

### REFERENCE LIST

10 detection device
12 detection chamber
14 light source
14.1 light sources
14.2 light sources
16 light sensor
18 walls
20 light channel
22 control unit
30 external device
32 server
34 cuvette
36 collar
40 data base
42 detection chamber
48 energy supply
50 power interface
52 wireless data interface
54 data memory
56 I2C data bus
60 printed circuit board
72 detection chamber housing
100 test system
110 analyte detection subsystem
120 test verification subsystem
130 trained neural network
132 neural network input layer
134 neural network hidden layer
136 neural network output layer
138 neural network node

1. A test system comprising a detection device and an analyte detection subsystem and a test verification subsystem, said detection device comprising a detection chamber and at least one light sensor for recording and/or sampling of light intensities of light in different frequency ranges over time, wherein the analyte detection subsystem and a test verification subsystem are two separate subsystems;
said analyte detection subsystem being configured to detect the presence of an analyte in a sample that is arranged in the detection chamber by comparing the magnitude of an output signal of light sensor that is sensitive for light caused by luminescence, and
said test verification subsystem being configured to process the time courses of light intensities for detecting test parameter values that can render a test invalid, wherein the test verification subsystem comprises a classifying neural network that is trained to discriminate input data sets representing valid tests from input data sets representing invalid tests.

2. The test system according to claim 1, wherein the light sensor of the detection device has at least two channels, a luminescence channel for capturing light in a luminescence frequency range in which luminescence occurs in case an analyte to be detected is present, and a reference channel for capturing light in a frequency range different from the luminescence frequency range.

3. The test system according to claim 2, wherein the verification subsystem is con-figured to generate normalized raw signal curves from the time series of the light sensor output value time series for the reference channel and/or the luminescence channel.

4. The test system according to claim 3, wherein the verification subsystem is con-figured to compare the raw signal curves with upper and lower threshold values and to trigger a warning signal in case a signal curve exceeds the upper threshold value or falls below the lower threshold value.

5. A detection device for a testing system, said detection device comprising a detection chamber, at least one light source, at least one light sensor and a control/evaluation unit,
said light source being configured and arranged to illuminate the detection chamber at least in part,
said light sensor being arranged to detect and record light in the detection chamber,
the light source, the light sensor and the detection chamber being configured and arranged so as to prevent light emitted from the light source from directly impinging the light sensor,
said light sensor has a luminescence channel and a reference channel for recording light in at least two different ranges of wavelengths and providing at least two time series of output signals, each time series of output signal representing the time course of an intensity of light in a respective range of wavelengths,
said control/evaluation unit being adapted to control recording of the at least two output signals of the light sensor,
characterized in that the detection device comprises or is connected to two separate subsystems, an analyte detection subsystem and a test verification subsystem,
said analyte detection subsystem being configured to detect the presence of an analyte in a sample that is arranged in the detection chamber, and
said test verification subsystem being configured to process the time series of output signals that represent the time courses of light intensities for detecting test parameter values that can render a test invalid.

6. The detection device according to claim 5, wherein the test verification subsystem comprises a neural network.

7. The detection device according to claim 5, wherein the test verification subsystem is configured
to generate normalized raw signal curves from the time series of the light sensor output value time series for the reference channel and/or the luminescence channel; and
to compare the raw signal curves with upper and lower threshold values and to trigger a warning signal in case a signal curve exceeds the upper threshold value or falls below the lower threshold value.

8. The detection device according to claim 5, wherein the analyte detection subsystem is configured to determine a ratio between the output values for a first range of wavelengths and the output values for a second range of wavelengths, the first range of wavelengths being captured by a luminescence channel of the light sensor and the second range of wavelengths being captured by a reference channel of the light sensor.

9. The detection device according to claim 8, wherein the analyte detection subsystem is configured to determine whether the ratio between the output values for a first range of wavelengths and the output values for a second range of wavelengths exceeds a predetermined threshold.

10. A method of operating a testing system comprising:
time sampling light-intensity values in at least two different regions of wavelengths (light channels) by means of a light sensor that produces output values reflecting sampled light intensity values and generating at least two time series of output values therefrom,
generating light intensity curves from the time series of the output values of the light sensor, and
analyzing the light intensity curves by comparing the light intensity curves with predetermined threshold values.

11. A method of operating a testing system comprising:
time sampling light-intensity values in at least two different regions of wavelengths (light channels) by means of a light sensor that produces output values reflecting sampled light intensity values and generating at least two time series of output values therefrom,
forwarding data sets (tensors) representing the at least two time series of output values to a trained neural network, and
using the output signal of the trained neural network for triggering or inhibiting a warning signal.

12. The method according to claim 11, wherein the trained neural network is a classifying neural network that is trained with training data sets that each represent at least one time series of output values produced in a testing procedure that was verified as being valid.

13. The method according to claim 11, wherein the trained neural network is a classifying neural network that is trained with training data sets that each represent at least two time series of output values produced in a testing procedure that was verified as being valid, a first time series representing raw output values of a luminescence channel of the light sensor and a second time series representing raw output values of a reference channel of the light sensor.
